(19) United States
(12) Patent Application Publication
(10) Pub. No.: US 2013/0159027 A1
(43) Pub. Date: Jun. 20, 2013

(54) METHODS AND SYSTEMS FOR TRAVEL BOOKING AND MANAGEMENT

(71) Applicants: Amir Naor, Tel-Aviv (IL); Maxim Drabkin, Akko (IL)

(72) Inventors: Amir Naor, Tel-Aviv (IL); Maxim Drabkin, Akko (IL)

(21) Appl. No.: 13/329,672

(22) Filed: Dec. 19, 2011

(51) Int. Cl. G06Q 10/02

(52) U.S. Cl. 705/5

(57) ABSTRACT

According to some embodiments, a travel kiosk located at a travel center may receive an identifier associated with a traveler. The travel kiosk may then access travel information associated with the identifier from an application server. The travel kiosk may also receive, via a motion detector, motion information from the traveler. Travel information may then be automatically updated by the travel kiosk based on the received motion information.

### FIELD

Some embodiments relate to travel booking and management. More specifically, some embodiments are directed to methods and systems for improved travel booking and management for travels.

### BACKGROUND

A traveler at a travel center may need to book or otherwise manage his or her travel arrangements. For example, a traveler at an airport might need to purchase an airline ticket or switch his or flight at the last minute. Typically, the traveler needs to wait on line and speak with a travel representative (e.g., at a ticket counter window) to book or manage his or her travel plans. This can be a time consuming process—which can be especially difficult when his or her changes need to be completed in a relatively timely manner (e.g., the traveler is attempting to re-schedule his or her ticket to catch a flight departing in twenty minutes).

In some cases, a travel kiosk may be provided to let a traveler book or otherwise manage his or her travel plans. Interactions with such kiosks, however, can be confusing and error prone. For example, many travelers may be unfamiliar with the use of such kiosks and may mistakenly make unintended selections. Moreover, arranging to pay for travel tickets might require that the traveler manually enter a payment identifier (e.g., a credit card number) which can lead to further errors and delays.

As a result, it can be difficult for a traveler to accurately and efficiently book and manage travel arrangements. Accordingly, a method and mechanism to efficiently, accurately, and automatically book and manage travel arrangements may be provided in accordance with some embodiments described herein.

### BRIEF DESCRIPTION OF THE DRAWINGS

FIG. 1 is a block diagram of a system according to some embodiments.

FIG. 2 is a flow diagram of a process according to one embodiment that might be implemented.

FIG. 3 is an illustration of a traveler using a travel kiosk in accordance with some embodiments.

FIG. 4 is an information flow diagram of a system in accordance with some embodiments

FIG. 5 is a block diagram of a travel kiosk according to some embodiments.

FIG. 6 is a portion of a local database in accordance with some embodiments.

FIG. 7 illustrates a travel kiosk display in accordance with some embodiments.

### DETAILED DESCRIPTION

A traveler at a travel center, such as an airport or railway station, may need to book or otherwise manage his or her travel arrangements. For example, a traveler might need to purchase an airline ticket or switch his or flight at the last minute. Typically, the traveler needs to wait on line and speak with a travel representative (e.g., at a ticket counter window) to book or manage his or her travel plans. This can be a time consuming process which can be especially difficult when his or her changes need to be completed in a relatively timely manner (e.g., the traveler is attempting to re-schedule his or her ticket to catch a flight departing in twenty minutes).

In some cases, a travel kiosk may be provided to let a traveler book or otherwise manage his or her travel plans. Interactions with such kiosks, however, can be confusing and error prone. For example, many travelers may be unfamiliar with the use of such kiosks and may mistakenly make unintended selections. Moreover, arranging to pay for travel tickets might require that the traveler manually enter a payment identifier (e.g., a credit card number) which can lead to further errors and delays.

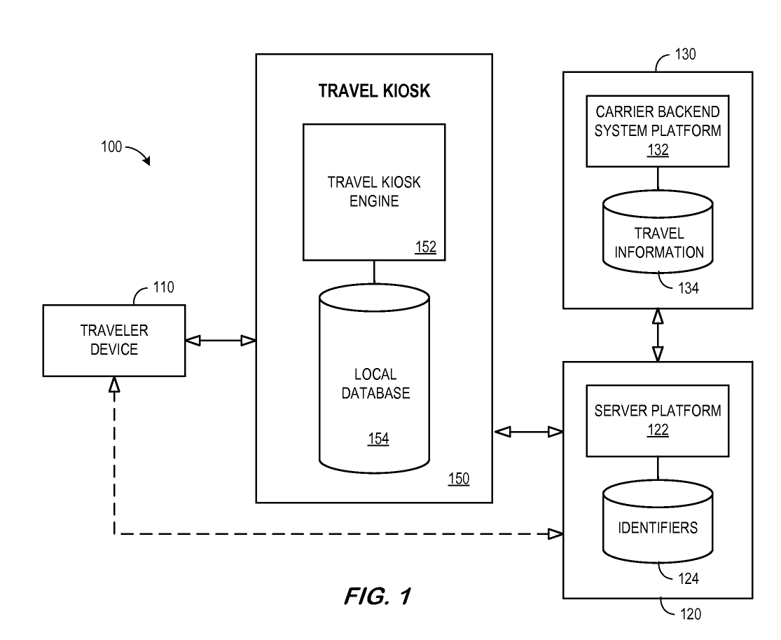

Thus, it can be difficult for a traveler to accurately and efficiently book and manage travel arrangements. Accordingly, a method and mechanism to efficiently, accurately, and automatically book and manage travel arrangements may be provided in accordance with some embodiments described herein. For example, FIG. 1 is a block diagram of a system 100 that includes a traveler device 110 that may interact with a travel kiosk 150 located at a travel center (e.g., an airport or railway station). The travel kiosk 150 includes a travel kiosk engine 152 that may establish a connection with a traveler via the remote traveler device 110. The travel kiosk engine 152 and/or traveler device 110 may comprise, for example, Personal Computers (PCs), laptop computers, servers, wireless smartphones, game systems, or another other appropriate device.

The travel kiosk engine 152 may store and retrieve information from one or more local databases 154. For example, the travel kiosk engine 152 may store and retrieve information about travel itineraries associated with the traveler device 110 (e.g., flight dates, numbers, and departure times) in the local database 154.

The travel kiosk 150 may access information from a carrier backend system 130 via an application server 120. The application server 120 may include, for example, a server platform 122 able to access traveler identifiers from an identifier database 124 and further able to communicate with a remote carrier backend system 130. The carrier backend system 130 may include a platform 132 able to access travel information from a travel information database 134 (e.g., associated with tickets that have been purchased by travelers). For example, the carrier backend system 130 may store travel information in connection with an enterprise data management system, such as Enterprise Resource Planning (“ERP”) information and/or Master Data Management (“MDM”) data. As used herein, ERP or MDM data may be associated with processes and/or tools that consistently define and manage data for an organization. Some of the ERP or MDM processes performed by the carrier backend system 130 may include, for example, collecting, aggregating, matching, consolidating, quality-assuring, persisting, and/or distributing travel information throughout an organization to ensure consistency and control in the ongoing maintenance and use of the travel information.

Note that FIG. 1 represents a logical architecture according to some embodiments, and actual implementations may include more or different components arranged in other manners. Moreover, each system described herein may be implemented by any number of devices in communication via any number of other public and/or private networks. Two or more of devices may be located remote from one another and may communicate with one another via any known manner of network(s) and/or a dedicated connection. Further, each device may comprise any number of hardware and/or software elements suitable to provide the functions described herein as well as any other functions. Other topologies may be used in conjunction with other embodiments.

Any of the devices illustrated in FIG. 1, including the traveler device 110, travel kiosk 150, application server 120, and carrier backend system 130 may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

All systems and processes discussed herein may be embodied in program code stored on one or more non-transitory computer-readable media. Such media may include, for example, a floppy disk, a CD-ROM, a DVD-ROM, magnetic tape, solid state Random Access Memory (“RAM”) or Read Only Memory (“ROM”) storage units. Embodiments are therefore not limited to any specific combination of hardware and software.

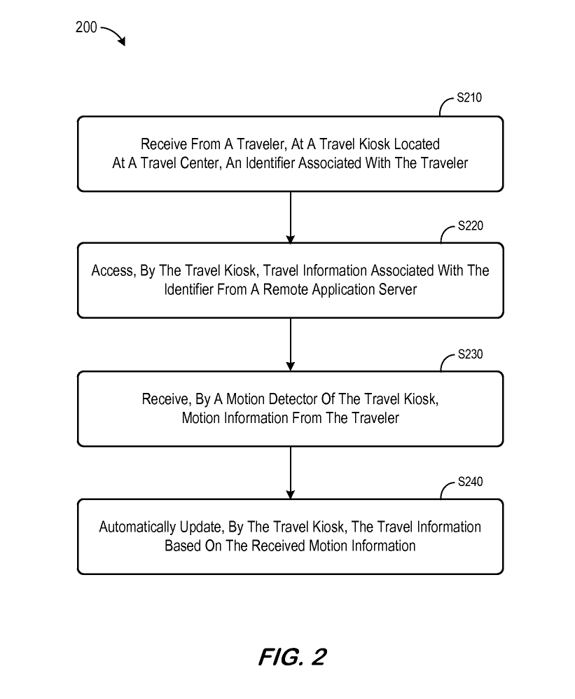

FIG. 2 is a flow diagram of a process 200 that might be associated with the travel kiosk 150 of FIG. 1 according to some embodiments. Note that all processes described herein may be executed by any combination of hardware and/or software. The processes may be embodied in program code stored on a tangible medium and executable by a computer to provide the functions described herein. Further note that the flow charts described herein do not imply a fixed order to the steps, and embodiments of the present invention may be practiced in any order that is practicable.

At S210, an identifier associated with a traveler may be received from the traveler at a travel kiosk located at a travel center. As used herein, the phrase “travel center” might refer to, for example, an airport terminal, a railroad station, a bus terminal, a port, a hotel, and/or a vehicle rental location. Moreover, the travel identifier might be manually entered by the traveler (e.g., by entering a user name and/or password). Examples of traveler identifiers include a traveler name, a traveler account number, a payment identifier (e.g., a credit or debit card number), a passport number, or a travel itinerary.

According to some embodiments, the identifier received by the travel kiosk is associated with a wireless communication between the travel kiosk and a mobile device associated with the traveler. The mobile device may comprise, for example, a mobile telephone, a smartphone, a mobile computer, a Personal Digital Assistant (“PDA”), or a laptop computer. Moreover, according to some embodiments, the wireless communication is associated with a Near Field Communication (“NFC”) protocol, a wireless payment card, and/or a communication enabled passport.

At S220, the travel kiosk may access travel information associated with the identifier from a remote application server. For example, the travel information may be received by the travel kiosk from a remote carrier backend system (e.g., an ERP or MDM system associated with an airline) via the application server.

The travel information might, for example, be associated with a travel ticket, hotel accommodations, a vehicle rental agreement, traveler preferences (e.g., a preferred airline), traveler default values (e.g., his or her hometown and list of usual destination), and/or travel offer information (e.g., advertisements and special offers selected for the traveler). According to some embodiments, the travel information is connected to a group of travelers associated with the identifier (e.g., his or her family or a group students traveling together).

At S230, a motion detector of the travel kiosk receives motion information from the traveler. The motion detector may be associated with, for example, a video signal, an image signal, and/or a touch signal. By way of example, a travel may move his or her arms and hands to select “change flight time” on a display of the travel kiosk. According to some embodiments, the motion detector may be associated with Kinect® motion sensing technology available from MICROSOFT® that enables users to control and interact with a computer through a natural user interface using gestures and spoken commands. According to other embodiments, the motion detector may be associated with a PlayStation Eye® digital camera device (similar to a webcam) available from SONY® that uses computer vision and gesture recognition to process images taken by the camera to let a traveler interact with an application using motion and color detection, as well as sound through a built-in microphone array.

At S240, the travel kiosk may automatically update the travel information based on the received motion information. As used herein, a process may be “automatic” if it requires little or no human action. The updated travel information might represent, for example, a new purchase, a modified ticket, a travel cancelation, and/or a frequent traveler reward program.

As previously noted, the travel kiosk and traveler device may communicate via a NFC protocol. In this case, it may be automatically arranged for the traveler to provide payment for the updated travel information in accordance with NFC information. For example, the NFC information may allow the traveler's credit card to be charged for his or her newly purchased airline tickets.

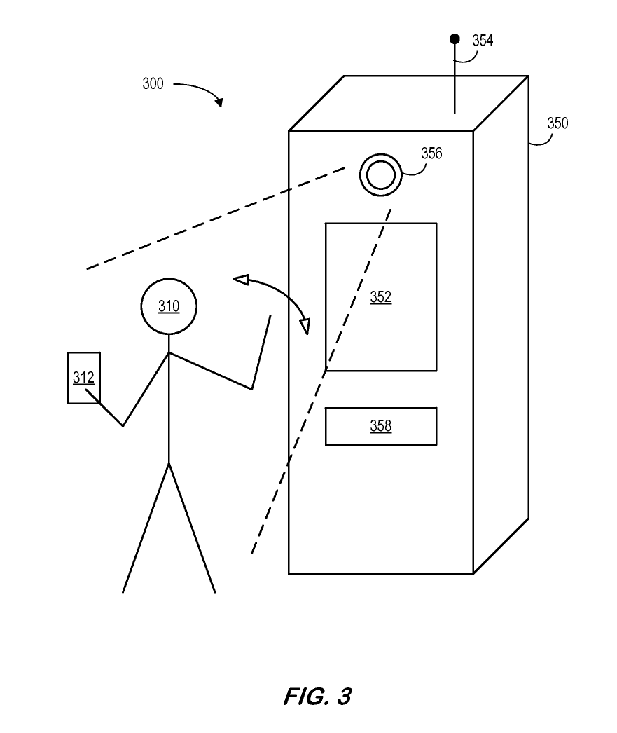

By way of example, FIG. 3 is an illustration 300 of a traveler 310 using a travel kiosk 350 in accordance with some embodiments. According to some embodiments, the traveler 310 may manually enter an identifier via a display 352 or a separate keypad. According to other embodiments, a traveler device 312 carried by the traveler 310 may wirelessly transmit the identifier to the kiosk 350 via an antenna 354. Information may then be provided to the traveler 310 via the display 352 of the kiosk 350 (e.g., his or her current travel itinerary).

A motion detector 356 of the travel kiosk 350 may then sense motions made by the traveler 310 within a field-of-view (illustrated by dashed lines in FIG. 3). For example, he or she might move an arm (illustrated by an arrow in FIG. 3) to select options on the display 352. In this way, the traveler 310 may book and manage his or her travel information. According to some embodiments, the travel kiosk 350 includes a printer 358 that might dispense, for example, an airline ticket, boarding pass, or travel itinerary to the traveler 310.

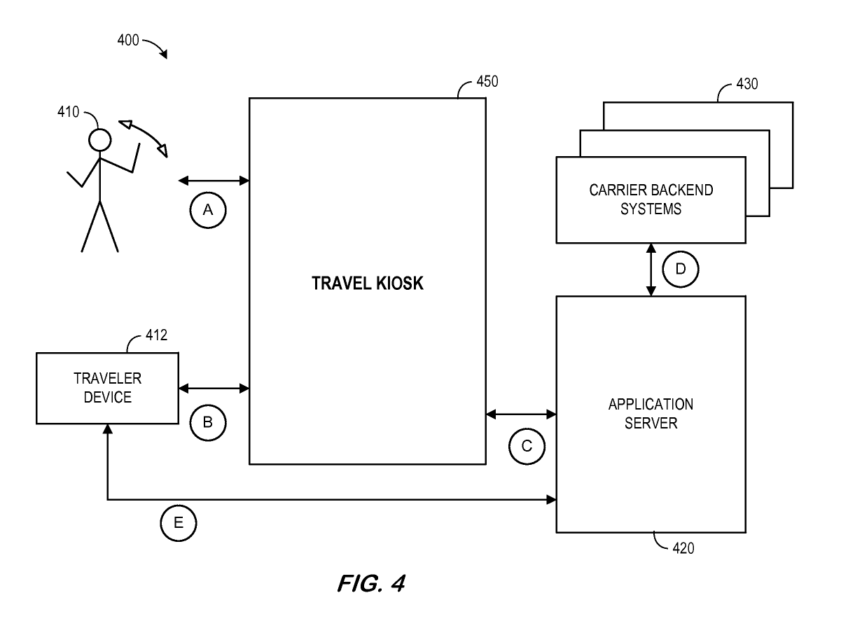

Thus, embodiments may provide for improved methods and systems to book and manage flight reservations (as compared to standard methods that may be non-intuitive and cumbersome). FIG. 4 is an information flow diagram of a system 400 in accordance with some embodiments. The system 400 may, for example, allow information originating from flight carrier enterprise systems (such as SAP® NetWeaver Gateway) to be leveraged together with modern technologies (e.g., Kinect sensor technology and NFC data) to let travelers naturally interact with a self-service kiosk to manage his or her flight reservation.

By using only his or her hands, the traveler can purchase tickets, see detailed flight information, check his or her frequent flyer points, etc. The traveler may be identified, according to some embodiments, using NFC technology embedded in his or her phone that stores identity data and allows him or her to securely pay for transactions.

At (A), a traveler 410 starts interacting with a travel kiosk 450 by using his or her hand movements. A Kinect sensor at the kiosk 450 might, for example, interpret these gestures as if he or she was moving a computer mouse. The traveler 410 may be asked what he or she would like to do (e.g., purchase an airline ticket).

At (B), the traveler 410 may need to identify himself or herself. He or she might, according to some embodiments, do so manually (e.g., by typing a traveler name/password) or automatically. According to other embodiments, the traveler 410 has a mobile phone 412 with NFC technology. The phone 412 has an application that stores a traveler-unique ID, and the application has the ability to communicate with the kiosk 450 via a Bluetooth or Wi-Fi connection or any other data method. To identify the traveler 410, according to some embodiments, he or she places the mobile phone 412 next to an NFC reader of the kiosk 450. At that point, the application on the mobile phone 412 may broadcast his or her identity (traveler ID) to the travel kiosk 450.

At (C), the traveler identity retrieved during (B) (either using manual entry or NFC data) the travel kiosk 450 may interact with an application server 420 to determine details about the traveler 410 and, for example, determine whether or not he or she already has existing reservations and/or pull available flights for the traveler 410.

At (D), the application server 420 may interact with different carriers backend systems 430 to retrieve business data (e.g., flight information and traveler frequent flyer points). This information may be displayed to the traveler 410 via the travel kiosk 450. The traveler 410 may then use motions to interact with the travel kiosk 450 to select a specific flight, view his or her itinerary, book a hotel, etc.

Once the traveler 410 makes a decision to buy a product or service on the travel kiosk 450 (e.g., to purchase a ticket), the application server 420 may send details of the purchase to his or her mobile phone 412 (via push mechanism) at (E). The details might include, for example, how he or she needs to confirm the transaction on the mobile phone 412 to complete the purchase. At that point, the application server 420 may send additional information to the mobile phone 412, such as a boarding pass, a ticket, coupons to stores in the terminal, his or her trip destinations, current frequent flyer points, etc.

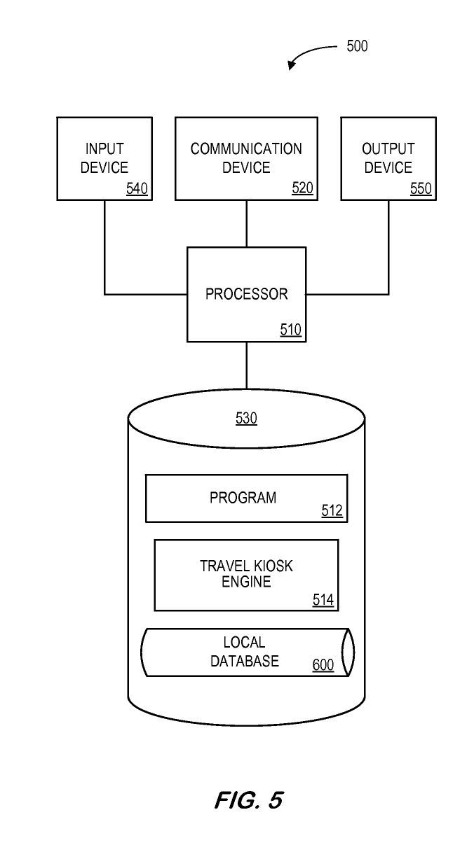

FIG. 5 is a block diagram overview of a travel kiosk 500 according to some embodiments. The travel kiosk 500 may be, for example, associated with the systems 100, 400 described with respect to FIGS. 1 and 4, respectively. The travel kiosk 500 comprises a processor 510, such as one or more commercially available Central Processing Units (CPUs) in the form of one-chip microprocessors, coupled to a communication device 520 configured to communicate via a communication network (not shown in FIG. 5). The communication device 520 may be used to communicate, for example, with one or more traveler devices or application servers. The travel kiosk 500 further includes an input device 540 (e.g., a motion sensor, touchscreen, and/or keyboard to receive information from a traveler) and an output device 550 (e.g., a computer monitor and/or printer to provide information to a traveler, such as a travel ticket).

The processor 510 communicates with a storage device 530. The storage device 530 may comprise any appropriate information storage device, including combinations of magnetic storage devices (e.g., a hard disk drive), optical storage devices, and/or semiconductor memory devices. The storage device 530 stores a program 512 and/or travel kiosk engine 514 for controlling the processor 510. The processor 510 performs instructions of the programs 512, 514, and thereby operates in accordance with any of the embodiments described herein. For example, the processor 510 may receive an identifier associated with a traveler. The processor 510 may then access travel information associated with the identifier from an application server. The processor 510 may also receive, via a motion detector, motion information from the traveler. Travel information may then be automatically updated by the processor 510 based on the received motion information.

The programs 512, 514 may be stored in a compressed, uncompiled and/or encrypted format. The programs 512, 514 may furthermore include other program elements, such as an operating system, a database management system, and/or device drivers used by the processor 510 to interface with peripheral devices.

As used herein, information may be “received” by or “transmitted” to, for example: (i) the travel kiosk 500 from another device; or (ii) a software application or module within the travel kiosk 500 from another software application, module, or any other source.

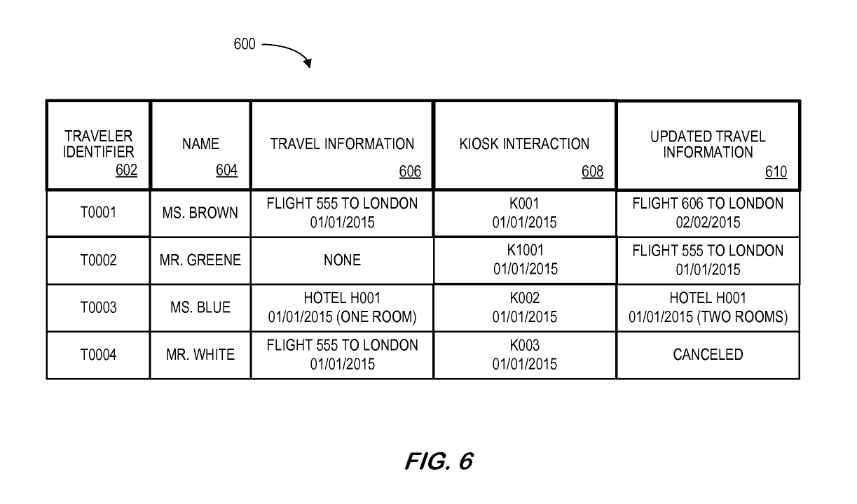

In some embodiments (such as shown in FIG. 5), the storage device 530 stores a local database 600 (described with respect to FIG. 6). An example of a database that may be used in connection with the travel kiosk 500 will now be described in detail with respect to FIG. 6. Note that the database described herein is only one example, and additional and/or different information may be stored therein. Moreover, various databases might be split or combined in accordance with any of the embodiments described herein.

Referring to FIG. 6, a table is shown that represents the local database 600 that may be stored at the travel kiosk 500 according to some embodiments. The table may include, for example, entries identifying travelers. The table may also define fields 602, 604, 606, 608, 610 for each of the entries. The fields 602, 604, 606, 608, 610 may, according to some embodiments, specify: a traveler identifier 602, a name 604, travel information 606, kiosk interaction 608, and updated travel information 610. The information in the local database 600 may be created and updated, for example, based on data received from a traveler, traveler device, and/or application server.

The traveler identifier 602 may be, for example, a unique alphanumeric code identifying a traveler. By ways of example only, the traveler identifier 602 might be based on or associated with a traveler account number, a payment identifier, a passport number, and/or a travel itinerary. The name 604 may represent the name of the traveler who is associated with the travel identifier 602. The travel information 606 might represent, for example, the traveler's initial travel plans that were received from a remote carrier backend via an application server (including, for example, a flight number, airline name, and date). The kiosk interaction 608 might be associated with, for example, recent interactions between a travel kiosk and the traveler (e.g., including, for example, a kiosk identifier and date). The updated travel information 610 might be based on the original travel information 606 as modified by the kiosk interaction 608. The updated travel information 610 could reflect, for example, a changed flight reservation, a newly purchased ticket, a canceled ticket, a hotel room reservation, etc.

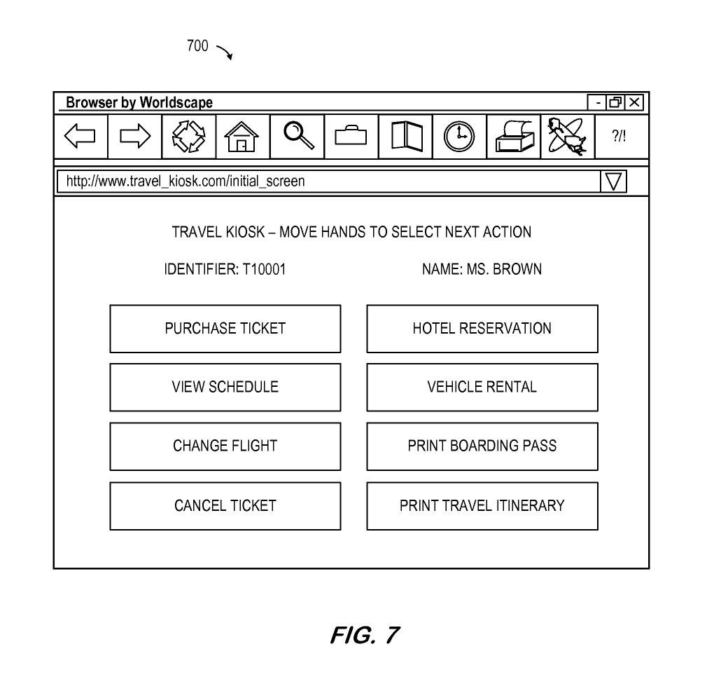

FIG. 7 illustrates a travel kiosk display 700 in accordance with some embodiments. In particular, the display 700 includes a travel identifier (“T0001”) and the associated traveler's name (“Ms. Brown”) that might have been determined, for example, via an NFC exchange of data between the kiosk and Ms. Brown's smartphone. The display 700 further includes a number of selections (“purchase ticket,” “view schedule,” “change flight,” etc.) that may be selected via motion inputs. For example, as Ms. Brown moves her hand in front of the kiosk, different selections may become highlighted. According to some embodiments, Ms. Brown might then activate a highlighted selection on the display 700, such by speaking an audio command.

Accordingly, a method and mechanism to efficiently, accurately, and automatically book and manage travel arrangements may be provided in accordance with some embodiments described herein.

The following illustrates various additional embodiments and do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although embodiments have been described with respect to particular types of travel reservations, note that embodiments may be associated with other types of transportation choices. For example, cruise ship reservations, local bus ticket requested, and vehicle rentals may be processed in accordance with any of the embodiments described herein.

Moreover, while embodiments have been illustrated using particular ways of providing motion inputs, embodiments may be implemented in any other of a number of different ways. For example, some embodiments might be associated with an audio based interaction system (e.g., using speech recognition) with a travel kiosk.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer-implemented method, comprising:
receiving from a traveler, at a travel kiosk located at a travel center, an identifier associated with the traveler;
accessing, by the travel kiosk, travel information associated with the identifier from a remote application server;
receiving, by a motion detector of the travel kiosk, motion information from the traveler; and
automatically updating, by the travel kiosk, the travel information based on the received motion information.

2. The method of claim 1, wherein the receiving of the identifier by the travel kiosk is associated with a wireless communication between the travel kiosk and a mobile device associated with the traveler.

3. The method of claim 2, wherein the mobile device comprises at least one of: (i) a mobile telephone, (ii) a smartphone, (iii) a mobile computer, (iv) a Personal Digital Assistant (“PDA”), or (v) a laptop computer.

4. The method of claim 2, wherein the wireless communication is associated with at least one of: (i) Near Field Communication (“NFC”) protocol, (ii) a wireless payment card, or (iii) a communication enabled passport.

5. The method of claim 1, wherein the travel center comprises at least one of: (i) an airport terminal, (ii) a railroad station, (iii) a bus terminal, (iv) a port, (v) a hotel, or (vi) a vehicle rental location.

6. The method of claim 1, wherein the identifier is associated with at least one of: (i) a traveler name, (ii) a traveler account number, (iii) a payment identifier, (iv) a passport number, or (v) a travel itinerary.

7. The method of claim 1, wherein the travel information is received by the travel kiosk from a remote carrier backend system via the application server.

8. The method of claim 1, wherein the remote carrier backend system is associated with (i) an Enterprise Resources Planning (“ERP”) system, or (ii) a Master Data Management (“MDM”) system.

9. The method of claim 1, wherein the travel information is associated with at least one of: (i) a travel ticket, (ii) hotel accommodations, (iii) a vehicle rental agreement, (iv) traveler preferences, (v) traveler default values, or (vi) travel offer information.

10. The method of claim 1, wherein the travel information is connected to a group of travelers associated with the identifier.

11. The method of claim 1, wherein the motion detector is associated with at least one of: (i) a video signal, (ii) an image signal, or (iii) a touch signal.

12. The method of claim 1, wherein the updated travel information is associated with at least one of: (i) a new purchase, (ii) a modified ticket, (iii) a travel cancelation, or (iv) a frequent traveler reward program.

13. The method of claim 1, wherein the wireless communication is associated with a Near Field Communication (“NFC”) protocol and further comprising:
automatically arranging for the traveler to provide payment for the updated travel information in accordance with NFC information.

14. A non-transitory, computer-readable medium storing program code executable by a computer processor associated with a travel kiosk to perform a method, wherein execution of the code causes the computer processor to:
receive from a traveler, at a travel kiosk located at an airport, an identifier associated with the traveler;
accessing, by the travel kiosk, airline ticket information associated with the identifier from a remote application server;
receiving, by a video signal motion detector of the travel kiosk, motion information from the traveler; and
automatically updating, by the travel kiosk, the airline ticket information based on the received motion information.

15. The medium of claim 14, wherein the identifier is received via a wireless communication associated with a Near Field Communication (“NFC”) protocol, and further wherein execution of the code causes the computer processor to:
automatically arrange for the traveler to provide payment for the updated airline ticket information in accordance with NFC information.

16. The medium of claim 14, wherein execution of the code causes the computer processor to:
visually display updated airline ticket information to the traveler via a display screen.

17. The medium of claim 14, wherein execution of the code causes the computer processor to:
print for the traveler at least one of: (i) an airline ticket, (ii) a boarding pass, or (iii) a travel itinerary.

18. A travel kiosk, comprising:
a wireless input device to receive an identifier from a mobile device associated with a traveler;
a communication port to access travel information associated with the identifier from a remote application server;
a display screen to display the travel information to the traveler;
a motion detector to receive motion information from the traveler; and
a travel kiosk engine to automatically update the travel information based on the received motion information.

19. The travel kiosk of claim 18, wherein the wireless input device is associated with a Near Field Communication (“NFC”) protocol, and further wherein the processor is to automatically arrange for the traveler to provide payment for the updated travel information in accordance with NFC information.

20. The travel kiosk of claim 18, further comprising:
a printer to print for the traveler at least one of: (i) an airline ticket, (ii) a boarding pass, or (iii) a travel itinerary.
